(19) United States
(12) Patent Application Publication
(10) Pub. No.: US 2020/0115543 A1
(43) Pub. Date: Apr. 16, 2020

(54) EPOXY RESIN COMPOSITION

(71) Applicant: DIC Corporation, Tokyo (JP)

(72) Inventors: Kazuhisa Yamoto, Ichihara-shi (JP); Nobuya Nakamura, Ichihara-shi (JP)

(21) Appl. No.: 16/470,479

(22) PCT Filed: Nov. 28, 2017
(86) PCT No.: PCT/JP2017/042549

§ 371 Date: Jun. 17, 2019

(30) Foreign Application Priority Data
Dec. 20, 2016 (JP) 2016-246983

(51) Int. Cl. C08L 63/00; C08G 59/20; C08K 3/013; C08K 3/36; C08K 3/08; C08K 7/06; C08J 5/24

(52) U.S. Cl. CPC C08L 63/00; C08G 59/20; C08K 3/013; C08K 3/36; C08K 3/08; C08K 7/06; C08K 2003/085; C08L 2201/08; C08L 2203/16; C08L 2203/206; C08K 2201/001; C08K 2003/0806; C08J 5/24

(57) ABSTRACT

[Abstract] An epoxy resin composition having an excellent balance among the shrinkage rate during cure-molding, heat resistance of the cured product, and the thermoelastic modulus of the cured product, is provided. More specifically, provided is an epoxy resin composition including a naphthalene-type epoxy compound and a curing agent for an epoxy resin, the naphthalene-type epoxy compound having: a naphthalene ring; at least one group (A) which is directly bonded to the naphthalene ring and selected from the group consisting of an allyl group and a glycidyl group; and at least one group (B) which is directly bonded to the naphthalene ring and selected from the group consisting of an allyloxy group and a glycidyloxy group, with the proviso that the compound has at least one of the allyl group and the allyloxy group and at least one of the glycidyl group and the glycidyloxy group.

### TECHNICAL FIELD

The present invention relates to an epoxy resin composition. The invention also relates to a resin material, semiconductor encapsulating material, semiconductor device, prepreg, circuit board, buildup film, fiber-reinforced composite material, and fiber-reinforced resin molded article using the epoxy resin composition.

### BACKGROUND ART

Epoxy resin compositions are used for adhesives, molding materials, coating materials, photoresist materials, color developing materials, and the like. Because their cured products have excellent heat resistance and moisture resistance, they are also widely used in the electric and electronic fields as semiconductor encapsulating materials, insulating materials for printed wiring boards, and the like.

For these uses, a variety of epoxy resin compositions have been studied so far. For example, PTL 1 describes a curable resin composition including: a polyvalent glycidyl compound (A) containing a glycidyl group and a glycidyl ether group bonded to the same aromatic ring in the molecule; and a phenol-based curing agent (B) containing a phenolic hydroxyl group having no substituent at its ortho-position. Further, PTL 2 describes an alkoxysilyl-based epoxy compound containing at least one alkoxysilyl group and at least two epoxy groups.

### CITATION LIST

### Patent Literatures

PTL 1: JP-A-2015-127397

PTL 2: JP-T-2015-535814 (the term “JP-T” as used herein means a published Japanese translation of a PCT patent application)

### SUMMARY OF INVENTION

### Technical Problem

The recent trend toward miniaturization and weight saving of electronic devices led to remarkable trends toward densification of semiconductor devices by narrowing of the wiring pitch. As a semiconductor mounting method applicable to such trends, the flip chip connection method, wherein a semiconductor device is connected to a substrate with solder balls, has been widely used.

The flip chip connection method is a semiconductor mounting method based on the so-called reflow method, wherein solder balls are placed between a wiring board and a semiconductor, and all of these are heated to allow melt joining. Thus, the wiring board itself is exposed to a hot environment during the solder reflow, causing warping of the wiring board due to heat shrinkage. This leads to generation of a large stress on the solder balls that connect the wiring board to the semiconductor, resulting in poor wiring connections in some cases. For the purpose of suppressing such warping of the wiring board, an encapsulating material having a high thermoelastic modulus and a high shrinkage rate has been demanded.

Further, in the field of semiconductor encapsulating materials, shifting to lead-free solders has led to an increased reflow process temperature, and therefore improvement of solder crack resistance (reflow resistance) has been demanded. Thus, for the semiconductor encapsulating materials, resin materials whose cured products have excellent heat resistance and thermal stability have been demanded.

An object of the invention is to provide an epoxy resin composition having an excellent balance among the shrinkage rate during cure-molding, heat resistance of the cured product, and the thermoelastic modulus of the cured product. Further, another object of the invention is to provide a resin material, semiconductor encapsulating material, semiconductor device, prepreg, circuit board, buildup film, fiber-reinforced composite material, and fiber-reinforced resin molded article, using the epoxy resin composition or a cured product thereof.

### Solution to Problem

One aspect of the invention relates to an epoxy resin composition including a naphthalene-type epoxy compound and a curing agent for an epoxy resin. In this epoxy resin composition, the naphthalene-type epoxy compound has: a naphthalene ring; at least one group (A) which is directly bonded to the naphthalene ring and selected from the group consisting of an allyl group and a glycidyl group; and at least one group (B) which is directly bonded to the naphthalene ring and selected from the group consisting of an allyloxy group and a glycidyloxy group, with the proviso that the compound has at least one of the allyl group and the allyloxy group and at least one of the glycidyl group and the glycidyloxy group.

Since this epoxy resin composition includes a naphthalene-type epoxy compound having a rigid naphthalene ring as a core structure, excellent heat resistance is given to its cured product. Further, since this naphthalene-type epoxy compound has not only an epoxy-containing group (glycidyl group or glycidyloxy group), but also an olefin-containing group (allyl group or allyloxy group), a cross-linked structure can be formed not only by cross-linking reaction between epoxy-containing groups, but also by cross-linking reaction between olefin-containing groups, so that a cured product having a complex cross-linked structure can be formed. It is conceivable that this complex cross-linked structure increases the shrinkage rate during cure-molding of the epoxy resin composition and the thermoelastic modulus of the cured product. Further, it is conceivable that, since the naphthalene-type epoxy compound contains a group (A) and a group (B) having different modes of bonding to the naphthalene ring, the cross-linked structure becomes more complex due to such a difference in the bonding mode, leading to further improvement of the shrinkage rate during the cure-molding and the thermoelastic modulus of the cured product.

In one mode, the naphthalene-type epoxy compound may have both the glycidyl group and the glycidyloxy group.

In one mode, the group (A) may be bonded to a position adjacent to the group (B) on the naphthalene ring.

Another aspect of the invention relates to a resin material including a cured product of the epoxy resin composition.

Still another aspect of the invention relates to a semiconductor encapsulating material including the epoxy resin composition, the epoxy resin composition further including an inorganic filler.

Still another aspect of the invention relates to a semiconductor device including an encapsulating material including a cured product of the semiconductor encapsulating material.

Still another aspect of the invention relates to a prepreg including a semi-cured product of an impregnated substrate including: a reinforcing substrate; and the epoxy resin composition with which the reinforcing substrate is impregnated.

Still another aspect of the invention relates to a circuit board including: a metal foil; and a cured resin layer including a cured product of the epoxy resin composition provided on the metal foil.

Still another aspect of the invention relates to a buildup film including the epoxy resin composition.

Still another aspect of the invention relates to a fiber-reinforced composite material including a cured product of the epoxy resin composition and reinforcing fibers.

Still another aspect of the invention relates to a conductive paste including the epoxy resin composition and conductive particles.

### Advantageous Effects of Invention

According to the invention, an epoxy resin composition having an excellent balance among the shrinkage rate during cure-molding, heat resistance of the cured product, and the thermoelastic modulus of the cured product, is provided.

### DESCRIPTION OF EMBODIMENTS

One preferred embodiment of the invention is described below. The invention is not limited to the following embodiment, and may be carried out, for example, by appropriately modifying the following embodiment without departing from the spirit of the invention.

<Epoxy Resin Composition>

The epoxy resin composition according to the embodiment includes a naphthalene-type epoxy compound and a curing agent for an epoxy resin.

In the embodiment, the naphthalene-type epoxy compound contains: a naphthalene ring; at least one group (A) which is directly bonded to the naphthalene ring and selected from the group consisting of an allyl group and a glycidyl group; and at least one group (B) which is directly bonded to the naphthalene ring and selected from the group consisting of an allyloxy group and a glycidyloxy group. Also, the naphthalene-type epoxy compound contains at least one epoxy-containing group which is directly bonded to the naphthalene ring and selected from the group consisting of a glycidyl group and a glycidyloxy group; and at least one olefin-containing group which is directly bonded to the naphthalene ring and selected from the group consisting of an allyl group and an allyloxy group.

Since the epoxy resin composition according to the embodiment contains a naphthalene-type epoxy compound containing a rigid naphthalene ring as a core structure, its cured product has excellent heat resistance. Further, since this naphthalene-type epoxy compound contains not only an epoxy-containing group, but also an olefin-containing group, a cross-linked structure can be formed not only by cross-linking reaction between epoxy-containing groups, but also by cross-linking reaction between olefin-containing groups, so that a cured product having a complex cross-linked structure can be formed. It is thought that this complex cross-linked structure increases the shrinkage rate during cure-molding of the epoxy resin composition and the thermoelastic modulus of the cured product. Further, it is thought that, since the naphthalene-type epoxy compound contains a group (A) and a group (B) having different modes of bonding to the naphthalene ring, the cross-linked structure becomes more complex due to such a difference in the bonding mode, leading to further improvement of the shrinkage rate during the cure-molding and the thermoelastic modulus of the cured product.

(Naphthalene-Type Epoxy Compound)

The naphthalene-type epoxy compound contains: a naphthalene ring; at least one group (A) which is directly bonded to the naphthalene ring and selected from the group consisting of an allyl group and a glycidyl group; and at least one group (B) which is directly bonded to the naphthalene ring and selected from the group consisting of an allyloxy group and a glycidyloxy group. The group (A) is bonded to the naphthalene ring through a carbon atom, and the group (B) is bonded to the naphthalene ring through an oxygen atom.

Here, the allyl group is a group represented by the following Formula (1-1), and the allyloxy group is a group represented by the following Formula (1-2). Here, each wavy line in Formulae (1-1) and (1-2) indicates that the group is directly bonded to the naphthalene ring. A glycidyl group is a group formed by epoxidation of the olefin moiety of an allyl group, and a glycidyloxy group is a group formed by epoxidation of the olefin moiety of an allyloxy group.

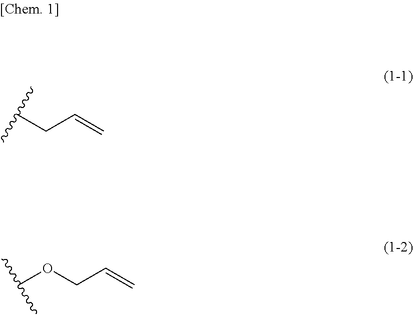

Further, in the naphthalene-type epoxy compound, at least one of the group (A) and the group (B) is at least one epoxy-containing group selected from the group consisting of a glycidyl group and a glycidyloxy group. The naphthalene-type epoxy compound has a function that causes curing of the epoxy resin composition by reaction between the epoxy-containing group and the curing agent for an epoxy resin.

Further, in the naphthalene-type epoxy compound, at least one of the group (A) and the group (B) is at least one olefin-containing group selected from the group consisting of an allyl group and an allyloxy group. Since the naphthalene-type epoxy compound contains not only the epoxy-containing group, but also the olefin-containing group, a cured product having a complex cross-linked structure can be formed.

The naphthalene-type epoxy compound may be one kind of compound having the above characteristics, or may be a mixture of a plurality of kinds of compounds.

In the naphthalene-type epoxy compound, the ratio of the total number of olefin-containing groups C₂ to the total number of epoxy-containing groups and olefin-containing groups C₁₊₂, that is, C₂/C₁₊₂, may be, for example, 0.1 or more, preferably 0.2 or more, and may be, for example, 0.9 or less, preferably 0.8 or less. As the ratio C₂/C₁₊₂ increases, the shrinkage rate during cure-molding and the thermoelastic modulus of the cured product tend to increase, while as the ratio C₂/C₁₊₂ decreases, the glass transition temperature of the cured product tends to increase.

In the naphthalene-type epoxy compound, at least one group (A) is preferably a glycidyl group, and at least one group (B) is preferably a glycidyloxy group. Thus, the naphthalene-type epoxy compound preferably contains a glycidyl group and a glycidyloxy group directly bonded to the naphthalene ring. Such a naphthalene-type epoxy compound contains epoxy-containing groups having different modes of bonding to the naphthalene ring, and a complex cross-linked structure can be formed because of such bonding modes.

In the naphthalene-type epoxy compound, the group (A) is preferably bonded to a position adjacent to the group (B) on the naphthalene ring. For example, in cases where the group (B) is bonded to the 1-position of the naphthalene ring in the naphthalene-type epoxy compound, the group (A) is preferably bonded to the 2-position of the naphthalene ring. Further, in cases where the group (B) is bonded to the 2-position of the naphthalene ring, the group (A) is preferably bonded to the 1-position or the 3-position of the naphthalene ring, more preferably bonded to the 1-position. Since a raw material compound for such a naphthalene-type epoxy compound can be simply synthesized by, for example, the method described in Synlett, 2006, 14, 2211, an excellent productivity can be achieved.

The naphthalene-type epoxy compound preferably has two or more groups (A) in the molecule. The number of groups (A) is preferably two to four, more preferably two or three.

The naphthalene-type epoxy compound preferably has two or more groups (B) in the molecule. The number of groups (B) is preferably two to four, more preferably two or three.

The naphthalene-type epoxy compound preferably has two or more epoxy-containing groups in the molecule. The number of epoxy-containing groups is preferably two to four, more preferably two or three.

With the naphthalene ring in the naphthalene-type epoxy compound, another ring may be condensed. Further, to the naphthalene ring in the naphthalene-type epoxy compound, a group other than the group (A) and the group (B) (hereinafter also referred to as another group) may be further bonded. “Another group” is not limited as long as curing of the epoxy resin composition is not inhibited. Examples of “another group” include halogeno groups (for example, fluoro, chloro, bromo, and iodo), alkoxy groups (for example, alkoxy groups having 1 to 10 carbon atoms), aryloxy groups (for example, aryloxy groups having 6 to 10 carbon atoms), acyl groups (for example, acyl groups having 1 to 10 carbon atoms), acyloxy groups (for example, acyloxy groups having 1 to 10 carbon atoms), and hydrocarbon groups (for example, hydrocarbon groups having 1 to 20 carbon atoms). Further, in these groups, the hydrogen atoms contained each group may be partially or entirely substituted with a halogeno group(s). Each group may contain at least one group selected from the group consisting of a secondary amino group, a tertiary amino group, an oxy group, and a carbonyl group inserted therein. Here, the term “may contain at least one group selected from the group consisting of a secondary amino group, a tertiary amino group, an oxy group, and a carbonyl group inserted” means that a secondary or tertiary amino group (—NR—), an oxy group (—O—), a carbonyl group (—C(═O)—), an amide group in which these are linked together (—C(═O)NR—), an oxycarbonyl group (—OC(═O)—), or the like may be inserted into a C—C bond or a C—H bond contained in the above group.

Examples of the alkoxy groups include methoxy, ethoxy, and t-butoxy. Further, examples of the alkoxy groups containing at least one group selected from the group consisting of a secondary amino group, a tertiary amino group, an oxy group, and a carbonyl group inserted therein include methoxyethoxy, methylcarboxy, and ethylcarboxy.

Examples of the aryloxy groups include phenoxy and tolyloxy. Examples of the aryloxy groups containing at least one group selected from the group consisting of a secondary amino group, a tertiary amino group, an oxy group, and a carbonyl group inserted therein include methoxyphenoxy, ethoxyphenoxy, and t-butoxyphenoxy.

Examples of the acyl groups include acetyl, propionyl, and benzoyl.

Examples of the acyloxy groups include acetyloxy, propionyloxy, and benzoyloxy.

Examples of the hydrocarbon groups include saturated hydrocarbon groups and unsaturated hydrocarbon groups. Each of the saturated hydrocarbon groups and the unsaturated hydrocarbon groups may be linear, branched, or cyclic. More specifically, examples of the hydrocarbon groups include alkyl groups (for example, methyl, t-butyl, and n-hexyl), cycloalkyl groups (for example, cyclohexyl), alkynyl groups (for example, ethynyl and propynyl), alkenyl groups (for example, ethenyl and propenyl), and aryl groups (for example, phenyl, benzyl, and tolyl). Examples of the hydrocarbon groups containing at least one group selected from the group consisting of a secondary amino group, a tertiary amino group, an oxy group, and a carbonyl group inserted therein include methoxymethyl and 2-methoxyethoxymethyl.

Examples of the naphthalene-type epoxy compound include a compound represented by the following Formula (2).

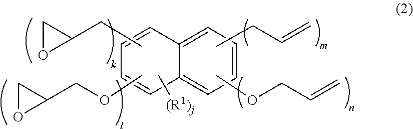

In Formula (2), R¹ represents a group other than the group (A) and the group (B). Here, j represents an integer of 0 to 6, and k, l, m, and n each independently represent an integer of 0 to 7, with the proviso that j+k+l+m+n is 2 to 8, that k+m is 1 to 7, that l+n is 1 to 7, that k+l is 1 to 7, and that m+n is 1 to 7.

k and l each independently represent preferably 1 to 4, more preferably 1 to 3, still more preferably 1 or 2. Further, at least one of k or 1 is preferably 2, and the other is more preferably 1 or 2. Further, k+m is preferably 2 to 4, more preferably 2 to 3, still more preferably 2. Further, l+n is preferably 2 to 4, more preferably 2 to 3, still more preferably 2.

Specific examples of the naphthalene-type epoxy compound include 1-glycidyloxy-5-allyloxy-2,6-diglycidylnaphthalene, 1-glycidyloxy-5-allyloxy-2-glycidyl-6-allylnaphthalene, 1-glycidyloxy-5-allyloxy-2,6-diallylnaphthalene, and 1,5-diallyloxy-2,6-diglycidylnaphthalene

The method of producing the naphthalene-type epoxy compound is not limited. For example, by providing a raw material compound containing: a naphthalene ring; and an allyl group and an allyloxy group directly bonded to the naphthalene ring; and performing partial epoxidation of the allyl group and the allyloxy group contained in the raw material compound, a naphthalene-type epoxy compound can be produced.

The content of the naphthalene-type epoxy compound in the epoxy resin composition may be, for example, 10% by mass or more, preferably 20% by mass or more, more preferably 30% by mass or more.

(Curing Agent for Epoxy Resin)

The curing agent for an epoxy resin is not limited as long as it is a component capable of cross-linking epoxy-containing groups contained in the naphthalene-type epoxy compound to each other.

Examples of the curing agent for an epoxy resin include various known curing agents such as amine-based compounds, amide-based compounds, acid anhydride-based compounds, and phenol-based compounds.

More specifically, examples of the amine-based compounds include diaminodiphenylmethane, diethylenetriamine, triethylenetetramine, diaminodiphenylsulfone, isophoronediamine, imidazole, BF₃-amine complex, and guanidine derivatives. Further, examples of the amide-based compounds include dicyandiamide, and polyamide resins synthesized with linolenic acid dimers and ethylenediamine. Further, examples of the acid anhydride-based compounds include phthalic anhydride, trimellitic anhydride, pyromellitic dianhydride, maleic anhydride, tetrahydrophthalic anhydride, methyltetrahydrophthalic anhydride, methylnadic anhydride, hexahydrophthalic anhydride, and methylhexahydrophthalic anhydride. Further, examples of the phenol-based compounds include polyvalent phenolic hydroxyl-containing compounds such as phenol novolac resins, cresol novolac resins, aromatic hydrocarbon formaldehyde resin-modified phenol resins, dicyclopentadienephenol addition-type resins, phenolaralkyl resins (Xyloc resin), naphtholaralkyl resins, triphenylolmethane resins, tetraphenylolethane resins, naphthol novolac resins, naphthol-phenol co-condensation novolac resins, naphthol-cresol co-condensation novolac resins, biphenyl-modified phenol resins (polyvalent phenolic hydroxyl-containing compounds in which phenol nuclei are linked through bismethylene groups), biphenyl-modified naphthol resins (polyvalent naphthol compounds in which phenol nuclei are linked through bismethylene groups), aminotriazine-modified phenol resins (polyvalent phenolic hydroxyl-containing compounds in which phenol nuclei are linked through melamine, benzoguanamine, or the like), and alkoxy-containing aromatic ring-modified novolac resins (polyvalent phenolic hydroxyl-containing compounds in which phenol nuclei and alkoxy-containing aromatic rings are linked through formaldehyde).

The content of the curing agent for an epoxy resin in the epoxy resin composition may be, for example, 0.001% by mass or more, preferably 0.01% by mass or more, more preferably 0.1% by mass or more. The content of the curing agent for an epoxy resin in the epoxy resin composition may be, for example, 90% by mass or less, preferably 80% by mass or less, more preferably 70% by mass or less.

(Other Components)

The epoxy resin composition may further contain a component other than the naphthalene-type epoxy compound and the curing agent for an epoxy resin.

For example, the epoxy resin composition may further contain a thermosetting resin other than the naphthalene-type epoxy compound.

Examples of the thermosetting resin include cyanate ester resins, resins having a benzoxazine structure, maleimide compounds, active ester resins, vinylbenzyl compounds, acrylic compounds, and copolymers of styrene and maleic anhydride. In cases where these thermosetting resins are used in combination, the amount of the resins is not limited as long as the effect mentioned above is not inhibited. For example, the amount is preferably less than 50% by mass with respect to the total amount of the epoxy resin composition.

Examples of the cyanate ester resins include bisphenol A-type cyanate ester resins, bisphenol F-type cyanate ester resins, bisphenol E-type cyanate ester resins, bisphenol S-type cyanate ester resins, bisphenol sulfide-type cyanate ester resins, phenylene ether-type cyanate ester resins, naphthylene ether-type cyanate ester resins, biphenyl-type cyanate ester resins, tetramethylbiphenyl-type cyanate ester resins, polyhydroxynaphthalene-type cyanate ester resins, phenol novolac-type cyanate ester resins, cresol novolac-type cyanate ester resins, triphenylmethane-type cyanate ester resins, tetraphenylethane-type cyanate ester resins, dicyclopentadiene-phenol addition reaction-type cyanate ester resins, phenol aralkyl-type cyanate ester resins, naphthol novolac-type cyanate ester resins, naphtholaralkyl-type cyanate ester resins, naphthol-phenol co-condensation novolac-type cyanate ester resins, naphthol-cresol co-condensation novolac-type cyanate ester resins, aromatic hydrocarbon formaldehyde resin-modified phenol resin-type cyanate ester resins, biphenyl-modified novolac-type cyanate ester resins, and anthracene-type cyanate ester resins. These may be used individually, or as a combination of two or more thereof.

Among these cyanate ester resins, from the viewpoint of obtaining a cured product having especially excellent heat resistance, bisphenol A-type cyanate ester resins, bisphenol F-type cyanate ester resins, bisphenol E-type cyanate ester resins, polyhydroxynaphthalene-type cyanate ester resins, naphthylene ether-type cyanate ester resins, and novolac-type cyanate ester resins are preferably used. From the viewpoint of obtaining a cured product having excellent dielectric properties, dicyclopentadiene-phenol addition reaction-type cyanate ester resins are preferred.

Examples of the resins having a benzoxazine structure include, but are not limited to, reaction products among bisphenol F, formalin, and aniline (F-a type benzoxazine resins); reaction products among diaminodiphenylmethane, formalin, and phenol (P-d type benzoxazine resins); reaction products among bisphenol A, formalin, and aniline; reaction products among dihydroxydiphenyl ether, formalin, and aniline; reaction products among diaminodiphenyl ether, formalin, and phenol; reaction products among dicyclopentadiene-phenol addition-type resin, formalin, and aniline; reaction products among phenolphthalein, formalin, and aniline; and reaction products among diphenyl sulfide, formalin, and aniline. These may be used individually, or as a combination of two or more thereof.

Examples of the maleimide compounds include compounds represented by the following Formulae (i) to (iii). A single kind of maleimide compound may be used alone, or two or more kinds of maleimide compounds may be used in combination.

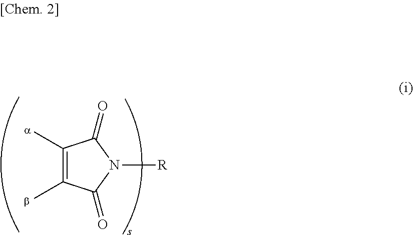

In Formula (i), R represents an s-valent organic group; α and β each independently represent a hydrogen atom, a halogen atom, an alkyl group, or an aryl group; and s represents an integer of 1 or more.

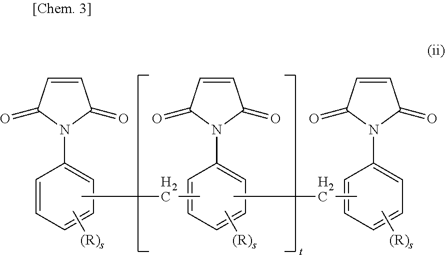

In Formula (ii), R represents a hydrogen atom, an alkyl group, an aryl group, an aralkyl group, a halogen atom, a hydroxyl group, or an alkoxy group; s represents an integer of 1 to 3; and t represents the average number of repeat units, which is 0 to 10.

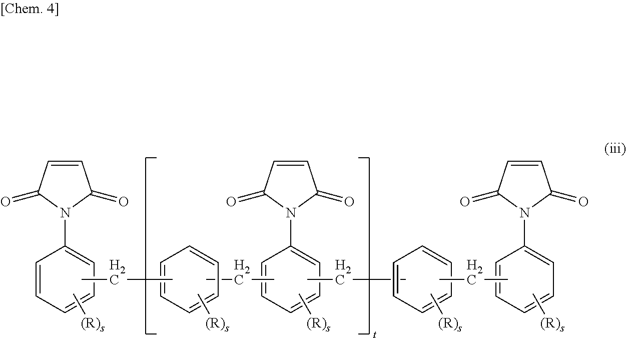

In Formula (iii), R represents a hydrogen atom, an alkyl group, an aryl group, an aralkyl group, a halogen atom, a hydroxyl group, or an alkoxy group; s represents an integer of 1 to 3; and t represents the average number of repeat units, which is 0 to 10.

The active ester resins are not limited. In general, a compound containing two or more ester groups having high reaction activity in the molecule, such as a phenol ester, a thiophenol ester, an N-hydroxyamine ester, or an ester of a heterocyclic hydroxy compound, is preferably used. The active ester resin is preferably obtained by condensation reaction of a carboxylic acid compound and/or a thiocarboxylic acid compound with a hydroxy compound and/or a thiol compound. In particular, from the viewpoint of increasing the heat resistance, an active ester resin obtained from a carboxylic acid compound or a halide thereof and a hydroxy compound is preferred. An active ester resin obtained from a carboxylic acid compound or a halide thereof and a phenol compound and/or a naphthol compound is more preferred. Examples of the carboxylic acid compound include benzoic acid, acetic acid, succinic acid, maleic acid, itaconic acid, phthalic acid, isophthalic acid, terephthalic acid, pyromellitic acid, and halides thereof. Examples of the phenol compound or the naphthol compound include hydroquinone, resorcin, bisphenol A, bisphenol F, bisphenol S, dihydroxydiphenyl ether, phenolphthalein, methylated bisphenol A, methylated bisphenol F, methylated bisphenol S, phenol, o-cresol, m-cresol, p-cresol, catechol, α-naphthol, β-naphthol, 1,5-dihydroxynaphthalene, 1,6-dihydroxynaphthalene, 2,6-dihydroxynaphthalene, dihydroxybenzophenone, trihydroxybenzophenone, tetrahydroxybenzophenone, phloroglucin, benzenetriol, and dicyclopentadiene-phenol addition-type resins.

More specifically, the active ester resin is preferably an active ester-based resin containing a dicyclopentadiene-phenol addition structure; an active ester resin containing a naphthalene structure; an active ester resin which is an acetylated product of a phenol novolac; an active ester resin which is a benzoylated product of a phenol novolac; or the like. In particular, from the viewpoint of achieving improved peel strength, an active ester resin containing a dicyclopentadiene-phenol addition structure or an active ester resin containing a naphthalene structure is more preferred. Specific examples of the active ester resin containing a dicyclopentadiene-phenol addition structure include compounds represented by the following General Formula (iv).

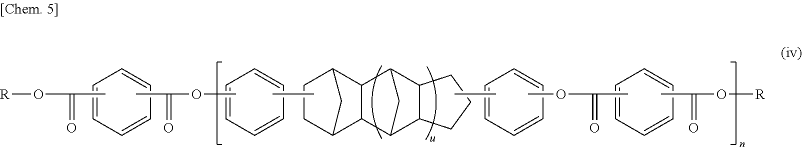

In Formula (iv), R represents a phenyl group or a naphthyl group; u represents 0 or 1; and n represents the average number of repeat units, which is 0.05 to 2.5. Here, from the viewpoint of decreasing the dielectric loss tangent of the cured product of the epoxy resin composition, and improving the heat resistance, R is preferably a naphthyl group; u is preferably 0; and n is preferably 0.25 to 1.5.

Although the epoxy resin composition according to the embodiment allows the curing to proceed even only with the naphthalene-type epoxy compound and the curing agent for an epoxy resin, a curing accelerator may be used in combination. Examples of the curing accelerator include imidazole and tertiary amine compounds such as dimethylaminopyridine; phosphorus-containing compounds such as triphenylphosphine; boron trifluoride and boron trifluoride amine complexes such as boron trifluoride monoethylamine complex; organic acid compounds such as thiodipropionic acid; benzoxazine compounds such as thiodiphenol benzoxazine and sulfonyl benzoxazine; and sulfonyl compounds. These may be used individually, or as a combination of two or more thereof. The amount of these catalysts is preferably within the range of 0.001 to 15% by mass with respect to the total amount of the epoxy resin composition.

For the purpose of obtaining high flame retardancy, a flame retardant may be included in the epoxy resin composition according to the embodiment. By this, the composition can be suitably used for uses requiring high flame retardancy. The flame retardant is preferably a non-halogenated flame retardant which substantially contains no halogen atom.

Examples of the non-halogenated flame retardant include phosphorus-based flame retardants, nitrogen-based flame retardants, silicone-based flame retardants, inorganic flame retardants, and organic metal salt-based flame retardants. These may be used individually. Alternatively, a plurality of flame retardants of the same system may be used. Alternatively, flame retardants of different systems may be used in combination.

As the phosphorus-based flame retardant, either an inorganic compound or an organic compound may be used. Examples of the inorganic compound include red phosphorus; ammonium phosphates such as monoammonium phosphate, diammonium phosphate, triammonium phosphate, and ammonium polyphosphate; and inorganic nitrogen-containing phosphorus compounds such as phosphorus amide.

The red phosphorus is preferably subjected to surface treatment for the purpose of preventing hydrolysis and the like. Examples of the surface treatment method include: (i) a method in which coating treatment is carried out with an inorganic compound such as magnesium hydroxide, aluminum hydroxide, zinc hydroxide, titanium hydroxide, bismuth oxide, bismuth hydroxide, bismuth nitrate, ora mixture thereof; (ii) a method in which coating treatment is carried out with a mixture of an inorganic compound such as magnesium hydroxide, aluminum hydroxide, zinc hydroxide, or titanium hydroxide, and a thermosetting resin such as a phenol resin; and (iii) a method in which a coating of an inorganic compound such as magnesium hydroxide, aluminum hydroxide, zinc hydroxide, or titanium hydroxide is coated with a thermosetting resin such as a phenol resin to perform double coating treatment.

Examples of the organic phosphorus compound include phosphoric acid ester compounds, phosphonic acid compounds, phosphinic acid compounds, phosphine oxide compounds, phosphorane compounds, and general-purpose organic phosphorus-containing compounds such as organic nitrogen-containing phosphorus compounds, and also include cyclic organic phosphorus compounds such as 9,10-dihydro-9-oxa-10-phosphaphenanthrene-10-oxide, 10-(2,5-dihydroxyphenyl)-10H-9-oxa-10-phosphaphenanthrene-10-oxide, and 10-(2,7-dihydroxynaphthyl)-10H-9-oxa-10-phosphaphenanthren e-10-oxide, and derivatives prepared by reacting these with a compound such as an epoxy resin or a phenol resin.

The content of the phosphorus-based flame retardant is appropriately selected according to, for example, the type of the phosphorus-based flame retardant, other components in the epoxy resin composition, and/or the desired degree of flame retardancy. For example, in cases where red phosphorus is used as a non-halogenated flame retardant, it is preferably included within the range of 0.1 to 2.0% by mass with respect to the total amount of the epoxy resin composition, and, in cases where an organic phosphorus compound is used, it is preferably similarly included within the range of 0.1 to 10.0% by mass, more preferably included within the range of 0.5 to 6.0% by mass.

In cases where a phosphorus-based flame retardant is used, it may be used in combination with hydrotalcite, magnesium hydroxide, boron compound, zirconium oxide, black dye, calcium carbonate, zeolite, zinc molybdate, activated carbon, and/or the like.

Examples of the nitrogen-based flame retardants include triazine compounds, cyanuric acid compounds, isocyanuric acid compounds, and phenothiazine. Triazine compounds, cyanuric acid compounds, and isocyanuric acid compounds are preferred.

Examples of the triazine compounds include melamine, acetoguanamine, benzoguanamine, melon, melam, succinoguanamine, ethylenedimelamine, melamine polyphosphate, and triguanamine, and also include: (1) aminotriazine sulfate compounds such as guanylmelamine sulfate, melem sulfate, and melam sulfate; (2) co-condensates of a phenol such as phenol, cresol, xylenol, butylphenol, or nonylphenol, a melamine such as melamine, benzoguanamine, acetoguanamine, or formguanamine, and formaldehyde; (3) mixtures of a co-condensate of (2) and a phenol resin such as a phenol formaldehyde condensate; and (4) products prepared by further modifying (2) or (3) with a tung oil, an isomerized linseed oil, or the like.

Examples of the cyanuric acid compounds include cyanuric acid and melamine cyanurate.

The content of the nitrogen-based flame retardant is appropriately selected according to, for example, the type of the nitrogen-based flame retardant, other components in the epoxy resin composition, and/or the desired degree of flame retardancy. For example, the nitrogen-based flame retardant is preferably included within the range of 0.05 to 10% by mass, more preferably included within the range of 0.1 to 5% by mass, with respect to the total amount of the epoxy resin composition.

In cases where a nitrogen-based flame retardant is used, it may be used in combination with a metal hydroxide, a molybdenum compound, and/or the like.

A silicone-based flame retardant may be used without limitation as long as it is an organic compound containing a silicon atom, and examples of such a silicone-based flame retardant include silicone oils, silicone rubbers, and silicone resins. The content of the silicone-based flame retardant is appropriately selected according to, for example, the type of the silicone-based flame retardant, other components in the epoxy resin composition, and/or the desired degree of flame retardancy. For example, the silicone-based flame retardant is preferably included within the range of 0.05 to 20% by mass with respect to the total amount of the epoxy resin composition. Further, in cases where a silicone-based flame retardant is used, it may be used in combination with a molybdenum compound, alumina, and/or the like.

Examples of the inorganic flame retardants include metal hydroxides, metal oxides, metal carbonate compounds, metal powders, boron compounds, and low-melting-point glasses.

Examples of the metal hydroxides include aluminum hydroxide, magnesium hydroxide, dolomite, hydrotalcite, calcium hydroxide, barium hydroxide, and zirconium hydroxide.

Examples of the metal oxides include zinc molybdate, molybdenum trioxide, zinc stannate, tin oxide, aluminum oxide, iron oxide, titanium oxide, manganese oxide, zirconium oxide, zinc oxide, molybdenum oxide, cobalt oxide, bismuth oxide, chromium oxide, nickel oxide, copper oxide, and tungsten oxide.

Examples of the metal carbonate compounds include zinc carbonate, magnesium carbonate, calcium carbonate, barium carbonate, basic magnesium carbonate, aluminum carbonate, iron carbonate, cobalt carbonate, and titanium carbonate.

Examples of the metal powders include aluminum, iron, titanium, manganese, zinc, molybdenum, cobalt, bismuth, chromium, nickel, copper, tungsten, and tin.

Examples of the boron compounds include zinc borate, zinc metaborate, barium metaborate, boric acid, and borax.

Examples of the low-melting-point glasses include glassy compounds such as Ceepree (Bokusui Brown Co., Ltd.), hydrated glass SiO₂—MgO—H₂O, and PbO—B₂O₃-based, ZnO—P₂O₅—MgO-based, P₂O₅—B₂O₃—PbO—MgO-based, P—Sn—O—F-based, PbO—V₂O₅—TeO₂-based, Al₂O₃—H₂O-based, and lead borosilicate-based compounds.

The content of the inorganic flame retardant is appropriately selected according to, for example, the type of the inorganic flame retardant, other components in the epoxy resin composition, and/or the desired degree of flame retardancy. For example, the inorganic flame retardant is preferably included within the range of 0.05 to 20% by mass, more preferably included within the range of 0.5 to 15% by mass, with respect to the total amount of the epoxy resin composition.

Examples of the organic metal salt-based flame retardants include ferrocene, acetylacetonato metal complexes, organic metal carbonyl compounds, organic cobalt salt compounds, organic sulfonic acid metal salts, and compounds containing a metal atom bonded to an aromatic compound or a heterocyclic compound by ionic bonding or coordinate bonding.

The content of the organic metal salt-based flame retardant is appropriately selected according to, for example, the type of the organic metal salt-based flame retardant, other components in the epoxy resin composition, and/or the desired degree of flame retardancy. For example, the organic metal salt-based flame retardant is preferably included within the range of 0.005 to 10% by mass with respect to the total amount of the epoxy resin composition.

When necessary, an inorganic filler may be included in the epoxy resin composition. Examples of the inorganic filler include molten silica, crystalline silica, alumina, silicon nitride, and aluminum hydroxide. In cases where a very large amount of inorganic filler is to be included, molten silica is preferably used. The molten silica may be in either a crushed shape or a spherical shape. From the viewpoint of increasing the amount of the molten silica included, and suppressing an increase in the melt viscosity of the molding material, spherical molten silica is more preferably used. For further increasing the amount of the spherical silica included, the particle size distribution of the spherical silica is preferably adjusted appropriately. Taking the flame retardancy into account, the filling factor is preferably high. The filling factor is especially preferably 20% by mass or more with respect to the total amount of the epoxy resin composition (including the inorganic filler). Here, the filling factor of the inorganic filler may be, for example, 95% by mass or less with respect to the total amount of the epoxy resin composition. Here, in cases of use for a conductive paste or the like, a conductive filler such as a silver powder or a copper powder may be used.

When necessary, the epoxy resin composition may further contain various agents such as silane coupling agents, mold release agents, pigments, and emulsifiers.

<Uses of Epoxy Resin Composition>

The epoxy resin composition according to the embodiment is excellent in the shrinkage rate during cure-molding, heat resistance of its cured product, and the thermoelastic modulus of the cured product. Thus, each of the epoxy resin composition, the cured product of the epoxy resin composition, and a resin material containing the cured product can be suitably used for various uses. For example, in the embodiment, the epoxy resin composition can be applied to a semiconductor encapsulating material, semiconductor device, prepreg, circuit board (printed circuit board, buildup substrate, or the like), buildup film, fiber-reinforced composite material, fiber-reinforced resin molded article, conductive paste, or the like.

1. Semiconductor Encapsulating Material

The semiconductor encapsulating material according to the embodiment includes the epoxy resin composition. The epoxy resin composition contains an inorganic filler, and may also contain other agents. The semiconductor encapsulating material may be prepared by, for example, melt mixing of a naphthalene-type epoxy compound, a curing agent for an epoxy resin, and an inorganic filler (and also other agents, when necessary) using an extruder, kneader, roll, or the like. As the inorganic filler, molten silica is normally used. Further, in cases of use as a high thermal conductive semiconductor encapsulating material to be used for a power transistor, power IC, or the like, a material having higher thermal conductivity such as crystalline silica, alumina, or silicon nitride may be used in a highly filled state.

The filling factor of the inorganic filler is, for example, preferably 30 to 95 parts by mass with respect to 100 parts by mass of the epoxy resin composition. Further, from the viewpoint of improving the flame retardancy, moisture resistance, and solder crack resistance, and reducing the coefficient of linear expansion, the filling factor of the inorganic filler is more preferably 70 parts by mass or more, still more preferably 80 parts by mass or more with respect to 100 parts by mass of the epoxy resin composition.

2. Semiconductor Device

The semiconductor device according to the embodiment includes an encapsulating material including a cured product of the semiconductor encapsulating material. The method of forming the encapsulating material is not limited, and examples of the method include a method in which a semiconductor encapsulating material is molded using a cast molding machine, transfer molding machine, injection molding machine, or the like, and then the molded product is heated at 50 to 200° C. for 2 to 10 hours.

In the embodiment, the configuration of the semiconductor device is not limited, and the device may have a known configuration, except for the encapsulating material. Thus, the semiconductor device according to the embodiment may be a device prepared by substituting an encapsulating material of a known semiconductor device with the above encapsulating material.

3. Prepreg

The prepreg according to the embodiment is a semi-cured product of an impregnated substrate including: a reinforcing substrate; and the epoxy resin composition with which the reinforcing substrate is impregnated. The method of producing the prepreg is not limited, and examples of the method include a method in which an epoxy resin composition is prepared into a varnish by blending with an organic solvent, and a reinforcing substrate (paper, glass fabric, glass non-woven fabric, aramid paper, aramid fabric, glass mat, glass roving fabric, or the like) is impregnated with the composition, followed by heating at a heating temperature suitable for the type of the solvent used (for example, at 50 to 170° C.). The ratio between the epoxy resin composition and the reinforcing substrate is not limited, and preferably adjusted such that, for example, the resin content in the prepreg is 20 to 60% by mass.

Examples of the organic solvent used herein include methyl ethyl ketone, acetone, dimethylformamide, methyl isobutyl ketone, methoxypropanol, cyclohexanone, methyl cellosolve, ethyl diglycol acetate, and propylene glycol monomethyl ether acetate. The type and the amount of the organic solvent used may be appropriately selected according to its use. For example, in cases where a printed circuit board is to be produced from a prepreg, a polar solvent having a boiling point of 160° C. or less, such as methyl ethyl ketone, acetone, or dimethylformamide is preferably used, and the solvent is preferably used at a ratio at which the nonvolatile content is 40% by mass to 80% by mass.

4. Circuit Board

The circuit board according to the embodiment includes a metal foil, and a cured resin layer provided on the metal foil, wherein the cured resin layer includes a cured product of the epoxy resin composition. Specific examples of the circuit board according to the embodiment include printed circuit boards and buildup substrates.

4-1. Printed Circuit Board

The printed circuit board according to the embodiment includes a metal foil, and a cured resin layer provided on the metal foil. In the embodiment, for example, the cured resin layer may include a cured product of the prepreg. Thus, the cured resin layer may contain a cured product of an epoxy resin composition, and a reinforcing substrate. Examples of the metal foil include copper foils. A copper foil is preferably used.

The configuration of the printed circuit board according to the embodiment is not limited except for the above configuration. For example, the printed circuit board may further have a configuration of a known printed circuit board.

The method of producing the printed circuit board is not limited. For example, the method of producing the printed circuit board may include a step of laminating the prepreg on a copper foil followed by heat-pressing under pressurization at 1 to 10 MPa at 170 to 300° C. for 10 minutes to 3 hours.

4-2. Buildup Substrate

The buildup substrate according to the embodiment includes a metal foil, and a cured resin layer provided on the metal foil, wherein the cured resin layer includes a cured product of the epoxy resin composition. Examples of the metal foil include copper foils. A copper foil is preferably used.

The configuration of the buildup substrate according to the embodiment is not limited except for the above configuration. For example, the buildup substrate may further have a configuration of a known buildup substrate.

The method of producing the buildup substrate is not limited. For example, the method of producing the buildup substrate may include the following Steps 1 to 3. First, in Step 1, an epoxy resin composition containing a rubber, filler, or the like as appropriate is applied to a circuit board using a spray coating method, curtain coating method, or the like, followed by curing of the composition. By Step 1, a cured resin layer containing the cured product of the epoxy resin composition is formed on the circuit board. In Step 2, holes such as predetermined through-holes are formed, when necessary, on the circuit board coated with the epoxy resin composition. Thereafter, treatment with a roughening agent is carried out, and then the surface is washed with hot water to form irregularities on the substrate, followed by plating with a metal such as copper. By Step 2, a metal foil is formed on the cured resin layer. In Step 3, the operations of Step 1 and Step 2 are sequentially repeated as desired to alternately build up resin insulating layers (cured resin layers) and conductor layers having a predetermined circuit pattern, to form a buildup substrate. Here, in this production method, the formation the though-holes is preferably carried out, for example, after formation of the outermost resin insulating layer.

Further, in another mode of the method of producing the buildup substrate, for example, a resin-coated metal foil prepared by semi-curing of an epoxy resin composition on a metal foil may be heat-pressed on a circuit board at 170 to 300° C. to form a roughened surface. By this, the plating process can be omitted.

5. Buildup Film

The buildup film according to the embodiment includes the epoxy resin composition. The buildup film according to the embodiment may include a base film, and a resin layer provided on the base film and including the epoxy resin composition. The buildup film may further have a protection film on the side of the resin layer opposite to the base film.

It is important for the buildup film to soften under temperature conditions for the lamination in the vacuum lamination method (usually 70 to 140° C.), and to show fluidity (resin flow) that allows filling of the resin into via-holes or through-holes on the circuit board during the lamination on the circuit board. The epoxy resin composition preferably contains each component such that such properties can be achieved.

Here, the through-holes on the circuit board have a diameter of usually 0.1 to 0.5 mm, and a depth of usually 0.1 to 1.2 mm. The buildup film is preferably capable of resin filling into such through-holes. Here, in cases where both sides of the circuit board are to be laminated, the resin may be filled to a depth of about ½ in the through-holes.

The method of producing the buildup film is not limited. Examples of the method of producing the buildup film include a method in which an epoxy resin composition is applied to a base film, and then the film is dried to allow formation of a resin layer. The epoxy resin composition may be prepared into a varnish by blending with an organic solvent before the application to the base film. Here, the drying of the organic solvent can be carried out by heating, hot-air blowing, or the like.

Preferred examples of the organic solvent include ketones such as acetone, methyl ethyl ketone, and cyclohexanone; acetic acid esters such as ethyl acetate, butyl acetate, cellosolve acetate, propylene glycol monomethyl ether acetate, and carbitol acetate; carbitols such as cellosolve and butyl carbitol; aromatic hydrocarbons such as toluene and xylene; dimethylformamide; dimethylacetamide; and N-methylpyrrolidone. The organic solvent is preferably used at a ratio at which the nonvolatile content is 30% by mass to 60% by mass.

The resin layer usually needs to have a thickness larger than the thickness of the conductor layer contained in the circuit board. Since the thickness of the conductor layer of the circuit board is usually within the range of 5 to 70 μm, the resin layer preferably has a thickness of 10 to 100 μm.

The resin layer may be protected with a protection film. By the protection with a protection film, adhesion of dust and the like on the resin layer surface and generation of flaws can be prevented.

Each of the base film and the protection film may be a resin film of polyolefin such as polyethylene, polypropylene, or polyvinyl chloride; polyester such as polyethylene terephthalate (which may be hereinafter simply referred to as “PET”) or polyethylene naphthalate; polycarbonate; or polyimide. Further, each of the base film and the protection film may be a mold release paper, metal foil (for example, a copper foil or an aluminum foil), or the like. Each of the base film and the protection film may be subjected to surface treatment such as matt finishing, corona treatment, or mold release treatment. The thickness of the support film is not limited, and usually 10 to 150 μm, preferably 25 to 50 μm. The thickness of the protection film is also not limited, and preferably 1 to 40 μm.

The base film may be peeled off after lamination of the buildup film on the circuit board, or after formation of a resin insulating layer by curing of the resin layer by heat curing. In cases where the base film is peeled off after heat curing of the resin layer of the buildup film, adhesion of dust and the like can be prevented during the curing step. In cases where the base film is peeled off after curing of the resin layer, the base film is preferably preliminarily subjected to mold release treatment.

The use of the buildup film is not limited. The buildup film may be used for, for example, production of a multilayer printed circuit board. In cases where, for example, the resin layer of the buildup film is protected with a protection film, the protection film is peeled off, and then lamination is carried out such that the resin layer directly contacts the circuit board on one side or both sides of the circuit board. The lamination can be carried out by, for example, the vacuum lamination method. Further, the method of the lamination may be either a batch method or a continuous method using a roll. Further, when necessary, the buildup film and the circuit board may be heated (preheated) prior to the lamination. Regarding the lamination conditions, the press-bonding temperature (lamination temperature) is preferably 70 to 140° C. The press-bonding pressure is preferably 1 to 11 kgf/cm² (9.8×10⁴ to 107.9×10⁴ N/m²). The lamination is preferably carried out under a reduced air pressure of 20 mmHg (26.7 hPa) or less.

6. Fiber-Reinforced Composite Material

The fiber-reinforced composite material according to the embodiment includes a cured product of the epoxy resin composition and reinforcing fibers. The fiber-reinforced composite material according to the embodiment may be a composite material prepared by impregnating reinforcing fibers with the epoxy resin composition followed by curing, or may be a composite material prepared by dispersing reinforcing fibers in the epoxy resin composition followed by curing.

The method of producing the fiber-reinforced composite material is not limited. For example, the fiber-reinforced composite material can be produced by impregnating a reinforcing fiber base material including reinforcing fibers with a varnish of the epoxy resin composition, and then performing polymerization reaction. The curing temperature during the polymerization reaction is, for example, preferably 50 to 250° C. It is preferred to perform curing at 50 to 100° C. to prepare a cured product in a tack-free state, and then to further perform treatment at 120 to 200° C.

The reinforcing fibers are not limited, and may be twisted yarns, untwisted yarns, or twistless yarns. From the viewpoint of achieving both moldability and mechanical strength of the fiber-reinforced resin molded article, the reinforcing fibers are preferably untwisted yarns or twistless yarns. Further, the form of the reinforcing fibers is also not limited. For example, fibers with a uniform fiber direction, or a fabric may be used. The fabric may be arbitrarily selected from plain fabrics, satin fabrics, and the like according to the part for which the fabric is used, and/or the intended use of the fabric.

Regarding the material of the reinforcing fibers, from the viewpoint of mechanical strength and durability, examples of the fibers include carbon fibers, glass fibers, aramid fibers, boron fibers, alumina fibers, and silicon carbide fibers. Two or more kinds among these may be used in combination. Among these, from the viewpoint of achieving especially excellent strength of molded articles, carbon fibers are preferred. Further, as the carbon fibers, various fibers such as polyacrylonitrile-based, pitch-based, or rayon-based fibers may be used. In particular, polyacrylonitrile-based fibers are preferred since high-strength carbon fibers can be simply obtained. In the process of impregnating a reinforcing fiber base material including reinforcing fibers with a varnish to provide a fiber-reinforced composite material, the amount of the reinforcing fibers used is preferably set such that the volume content of the reinforcing fibers in the fiber-reinforced composite material falls within the range of 40% to 85%.

7. Fiber-Reinforced Resin Molded Article

The fiber-reinforced resin molded article according to the embodiment may include the fiber-reinforced composite material. The fiber-reinforced resin molded article according to the embodiment can also be said to be a molded article including reinforcing fibers and a cured product of the epoxy resin composition.

The method of producing the fiber-reinforced resin molded article is not limited. For example, the fiber-reinforced resin molded article can be obtained by heat curing of a composite material containing the epoxy resin composition and the reinforcing fiber. Further, the fiber-reinforced resin molded article may also be produced by the hand lay-up method, in which a fiber skeleton is placed in a mold, and a varnish of the epoxy resin composition is multiply layered, or by the spray-up method. Further, the fiber-reinforced resin molded article may also be produced by the vacuum bag method, in which a reinforcing fiber base material including reinforcing fibers is multiply layered and molded using a male mold or a female mold while impregnating the material with a varnish, and then the molded product is covered with a flexible mold capable of applying pressure to the molded product, followed by hermetic sealing and vacuum (reduced-pressure) molding. Further, the fiber-reinforced resin molded article may also be produced by producing a prepreg of reinforcing fibers impregnated with a varnish, and then baking the prepreg in a large-scale autoclave or the like, wherein the production of the prepreg is carried out by a method such as the SMC press method, in which the reinforcing fibers are mixed with a varnish of the epoxy resin composition, and then molded into a sheet shape, followed by compression molding using a mold, or the RTM method, in which a varnish of the epoxy resin composition is injected into a combination mold in which the reinforcing fibers are tightly placed.

The amount of the reinforcing fibers in the fiber-reinforced resin molded article is preferably 40 to 70% by mass. From the viewpoint of strength, the amount is especially preferably 50 to 70% by mass.

8. Conductive Paste

The conductive paste according to the embodiment includes the epoxy resin composition and conductive particles. Examples of the conductive particles include silver particles and copper particles.

The conductive paste can be used for uses such as a resin paste for circuit connection, or an anisotropic conductive adhesive. The conductive particles in the conductive paste may be appropriately selected according to such uses.

A preferred embodiment of the invention is as described above, but the invention is not limited to this embodiment.

### EXAMPLES

The invention is described below more concretely byway of Examples, but the invention is not limited to the Examples.

### Synthesis Example 1-1

According to the method described in Synlett, 2006, 14, 2211, 1,5-dihydroxynaphthalene was used as a raw material to synthesize 1,5-diallyloxy-2,6-diallylnaphthalene, which is represented by the following formula.

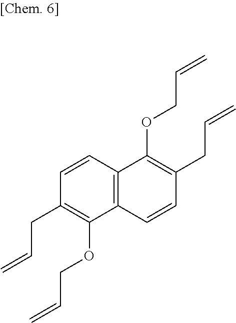 [SMILES: C=CCOc1c(CC=C)ccc2c(OCC=C)c(CC=C)ccc12]

### Synthesis Example 2-1

In a 2.0-L eggplant flask, sodium tungstate dihydrate (26.6 g, 80.6 mmol), methyl tri-n-octylammonium hydrogen sulfate (38.5 g, 82.7 mmol), methylene diphosphonic acid (3.5 g, 19.9 mmol), sodium sulfate (102.5 g, 721.8 mmol), and 1,5-diallyloxy-2,6-diallylnaphthalene (80.3 g, 250.6 mmol) were dissolved in toluene (500 mL). Subsequently, 30% hydrogen peroxide solution (192.3 g, 1.70 mol) was added to the resulting solution, and reaction was carried out at 40° C. for 16 hours. Thereafter, toluene (1000 mL) was added to the solution, and the organic layer was separated. After three times of separation washing with distilled water (500 mL), the solvent was removed by distillation under reduced pressure, to obtain an epoxy compound A-1 (75.3 g) as a brown solid.

As a result of analysis of the epoxy compound A-1, the degree of conversion of olefin-containing groups was 88%; the yield of epoxy-containing groups was 81%; the epoxidation selectivity was 92%; and the epoxy equivalent was 128 g/eq. Here, the degree of conversion of olefin-containing groups, the yield of epoxy-containing groups, and the epoxidation selectivity can be determined according to the following calculation equations based on the result of ¹H NMR analysis.

Degree of conversion of olefin-containing groups (%)=(1−total amount of unreacted olefin-containing groups (mol)/total amount of olefin-containing groups in raw material compound (mol))×100

Yield of epoxy-containing groups (%)=(total amount of epoxy-containing groups produced (mol)/total amount of olefin-containing groups in raw material compound (mol))×100

Epoxidation selectivity (%)=(yield of epoxy-containing groups/degree of conversion of olefin-containing groups)×100

### Synthesis Example 2-2

In a 2.0-L eggplant flask, sodium tungstate dihydrate (26.6 g, 80.6 mmol), methyl tri-n-octylammonium hydrogen sulfate (38.5 g, 82.7 mmol), methylene diphosphonic acid (3.5 g, 19.9 mmol), sodium sulfate (102.5 g, 721.8 mmol), and 1,5-diallyloxy-2,6-diallylnaphthalene (80.3 g, 250.6 mmol) were dissolved in toluene (500 mL). Subsequently, 30% hydrogen peroxide solution (147.3 g, 1.1 mol) was added to the resulting solution, and reaction was carried out at 40° C. for 16 hours. Thereafter, toluene (1000 mL) was added to the solution, and the organic layer was separated. After three times of separation washing with distilled water (500 mL), the solvent was removed by distillation under reduced pressure, to obtain an epoxy compound A-2 (65.4 g) as a brown solid.

As a result of analysis of the epoxy compound A-2, the degree of conversion of olefin-containing groups was 58%; the yield of epoxy-containing groups was 53%; the epoxidation selectivity was 91%; and the epoxy equivalent was 181 g/eq.

### Example 1

A mixture of 104 parts by mass of the epoxy compound A-1, 85 parts by mass of a curing agent (manufactured by DIC Corporation, TD-2131: phenol novolac resin, hydroxyl equivalent: 104 g/eq), 3 parts by mass of a curing accelerator (manufactured by Hokko Chemical Industry Co., Ltd.; triphenylphosphine), 800 parts by mass of molten silica (manufactured by Denki Kagaku Kogyo Co., Ltd.; spherical silica FB-560), 3 parts by mass of a silane coupling agent (manufactured by Shin-Etsu Chemical Co., Ltd.; γ-glycidoxytriethoxysilane KBM-403), 2 parts by mass of a carnauba wax (manufactured by Denki Kagaku Kogyo Co., Ltd.; PEARL WAX No. 1-P), and 3 parts by mass of carbon black (manufactured by Mitsubishi Chemical Corporation; #2600) was prepared, and then melt-kneaded using two rolls at a temperature of 90° C. for 5 minutes, to obtain an epoxy resin composition of interest.

<Measurement of Glass Transition Temperature and Thermoelastic Modulus>

Subsequently, a ground product of the resulting epoxy resin composition was molded into a disk shape of 50 mm (diameter)×3 mm (thickness) using a transfer molding machine at a pressure of 70 kg/cm² and a temperature of 175° C. for a period of 180 seconds. The product was further cured at 180° C. for 5 hours to obtain a cured molded product of the epoxy resin composition.

The cured molded product of the epoxy resin composition was cut out into a size of 0.8 mm thickness, 5 mm width, and mm length, to provide a test piece 1. Using a viscoelasticity measuring apparatus (DMA: solid viscoelasticity measuring apparatus “RSA II” manufactured by Rheometrics Inc., rectangular tension method: frequency, 1 Hz; heating rate, 3° C./minute), the test piece 1 was subjected to measurement of the glass transition temperature and the thermoelastic modulus, wherein the temperature at which the change in the elastic modulus was maximum (that is, the rate of change in tan 8 was largest) was regarded as the glass transition temperature, and the storage elastic modulus at 260° C. was regarded as the thermoelastic modulus.

<Measurement of Shrinkage Rate During Molding>

The shrinkage rate during molding was measured by the following method. First, using a transfer molding machine (manufactured by Kohtaki Corporation, KTS-15-1.5C), injection molding of an epoxy resin composition was carried out at a mold temperature of 150° C., molding pressure of 9.8 MPa, and a curing period of 600 seconds to obtain a test piece of 110 mm length, 12.7 mm width, and 1.6 mm thickness. Thereafter, the test piece was post-cured at 175° C. for 5 hours, and the inner diameter of the mold cavity was measured. Finally, the outer diameter of the test piece after the post cure was measured at room temperature (25° C.). Based on the longitudinal length of the mold at 25° C. (hereinafter referred to as mold length at 25° C.), the longitudinal length of the test piece after the post cure (hereinafter referred to as cured product length at 25° C.), and the longitudinal length of the mold at 175° C. (hereinafter referred to as mold length at 175° C.), the shrinkage rate was calculated according to the following equation.

Shrinkage rate (%)=[(mold length at 25° C.)−(cured product length at 25° C.)]/(mold length at 175° C.)×100(%)

### Example 2

An epoxy resin composition was prepared and evaluated in the same manner as in Example 1 except that 120 parts by mass of epoxy compound A-2 was used instead of epoxy compound A-1, and that the amount of the curing agent was 69 parts by mass. The evaluation results are shown in Table 1.

### Comparative Example 1

An epoxy resin composition was prepared and evaluated in the same manner as in Example 1 except that 122 parts by mass of the compound represented by the following formula (manufactured by DIC Corporation, EPICLON 850-S) was used instead of epoxy compound A-1, and that the amount of the curing agent was 67 parts by mass. The evaluation results are shown in Table 1.

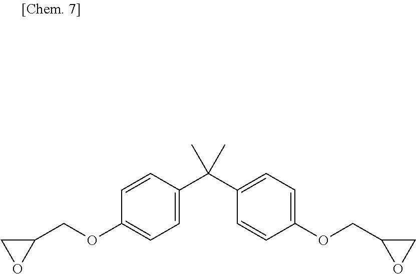 [SMILES: CC(C)(c1ccc(OCC2CO2)cc1)c1ccc(OCC2CO2)cc1]

### Comparative Example 2

An epoxy resin composition was prepared and evaluated in the same manner as in Example 1 except that 109 parts by mass of the compound represented by the following formula (manufactured by DIC Corporation, EPICLON HP-4032D) was used instead of epoxy compound A-1, and that the amount of the curing agent was 80 parts by mass. The evaluation results are shown in Table 1.

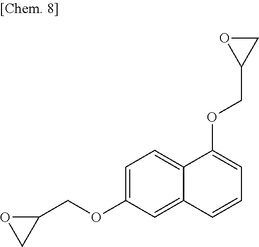 [SMILES: c1cc(OCC2CO2)c2ccc(OCC3CO3)cc2c1]

### Comparative Example 3

An epoxy resin composition was prepared and evaluated in the same manner as in Example 1 except that 98 parts by mass of the tetrafunctional type represented by the following formula (a compound synthesized from bisphenol A according to the non-patent document Synlett, 2006, 14, 2211.) was used instead of epoxy compound A-1, and that the amount of the curing agent was 91 parts by mass. The evaluation results are shown in Table 1.

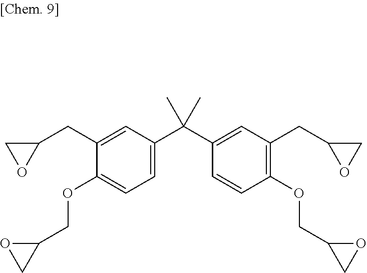 [SMILES: CC(C)(c1ccc(OCC2CO2)c(CC2CO2)c1)c1ccc(OCC2CO2)c(CC2CO2)c1]

TABLE 1

| | | | Compar- | Compar- | Compar- |
|---|---|---|---|---|---|
| | | | ative | ative | ative |
| | Exam- | Exam- | Exam- | Exam- | Exam- |
| | ple 1 | ple 2 | ple 1 | ple 2 | ple 3 |
| Glass transition | 193 | 170 | 158 | 172 | 185 |
| temperature (° C.) | | | | | |
| Elastic modulus | 270 | 345 | 75 | 85 | 50 |
| at 260° C. (MPa) | | | | | |
| Shrinkage rate | 1.1 | 1.3 | 0.8 | 0.6 | 0.6 |
| (%) | | | | | |

### INDUSTRIAL APPLICABILITY

The epoxy resin composition according to the invention can be suitably used for uses such as a semiconductor encapsulating materials, semiconductor devices, prepregs, circuit boards, buildup films, fiber-reinforced composite materials, fiber-reinforced resin molded articles, and conductive pastes.

1. An epoxy resin composition comprising a naphthalene-type epoxy compound and a curing agent for an epoxy resin,
the naphthalene-type epoxy compound having: a naphthalene ring; at least one group (A) which is directly bonded to the naphthalene ring and selected from the group consisting of an allyl group and a glycidyl group; and at least one group (B) which is directly bonded to the naphthalene ring and selected from the group consisting of an allyloxy group and a glycidyloxy group, with the proviso that the compound has at least one of the allyl group and the allyloxy group and both of the glycidyl group and the glycidyloxy group.

2. (canceled)

3. The epoxy resin composition according to claim 1, wherein the group (A) is bonded to a position adjacent to the group (B) on the naphthalene ring.

4. A resin material comprising a cured product of the epoxy resin composition according to claim 1.

5. A semiconductor encapsulating material comprising the epoxy resin composition according to claim 1, the epoxy resin composition further comprising an inorganic filler.

6. A semiconductor device comprising an encapsulating material comprising a cured product of the semiconductor encapsulating material according to claim 5.

7. A prepreg comprising a semi-cured product of an impregnated substrate comprising: a reinforcing substrate; and the epoxy resin composition according to claim 1 with which the reinforcing substrate is impregnated.

8. A circuit board comprising: a metal foil; and a cured resin layer comprising a cured product of the epoxy resin composition according to claim 1 provided on the metal foil.

9. A buildup film comprising the epoxy resin composition according to claim 1.

10. A fiber-reinforced composite material comprising a cured product of the epoxy resin composition according to claim 1 and reinforcing fibers.

11. A conductive paste comprising the epoxy resin composition according to claim 1 and conductive particles.

12. A resin material comprising a cured product of the epoxy resin composition according to claim 2.

13. A semiconductor encapsulating material comprising the epoxy resin composition according to claim 2, the epoxy resin composition further comprising an inorganic filler.

14. A semiconductor device comprising an encapsulating material comprising a cured product of the semiconductor encapsulating material according to claim 13.
